(19) United States
(12) Patent Application Publication
(10) Pub. No.: US 2018/0305534 A1
(43) Pub. Date: Oct. 25, 2018

(54) Methods for Making Polypropylene and Compositions Made Thereby

(71) Applicant: ExxonMobil Chemical Patents Inc., Baytown, TX (US)

(72) Inventors: Jan Kalfus, Spring, TX (US); Patrick Brant, Seabrook, TX (US); Gabor Kiss, Hampton, NJ (US); Abdul M. Jangda, Humble, TX (US)

(21) Appl. No.: 15/774,753

(22) PCT Filed: Sep. 16, 2016
(86) PCT No.: PCT/US2016/052148

§ 371 Date: May 9, 2018

Related U.S. Application Data
(60) Provisional application No. 62/273,690, filed on Dec. 31, 2015.

(30) Foreign Application Priority Data
Mar. 15, 2016 (EP) 16160371.7

(51) Int. Cl. C08L 23/12

(52) U.S. Cl. CPC C08L 23/12; C08L 2205/025

(57) ABSTRACT

Provided are methods for making a polypropylene composition having a first polypropylene and second polypropylene, and compositions made therefrom. Also provided are bimodal polypropylene compositions having desirable flexural modulus and shear thinning properties.

### CROSS REFERENCE TO RELATED APPLICATIONS

This application claims the benefit of priority from U.S. Provisional Application No. 62/273,690, filed Dec. 31, 2015, and EP Application No. 16160371.7, filed Mar. 15, 2016, which are incorporated herein by reference.

### FIELD OF THE INVENTION

The invention encompasses methods for making polypropylene, in particular bimodal polypropylene compositions having high modulus and shear thinning.

### BACKGROUND OF THE INVENTION

Polypropylene solution processes using single-site (e.g., metallocene) catalysts have several advantages. For example, such processes can avoid the need to combine the catalyst on a support. Such catalyst supports often degrade tacticity and reduce catalyst productivity. A homogeneous solution polymerization provides for simpler and more efficient in-line processes to produce polypropylene polymer blends such as spun-bond polypropylene-based elastomers, impact copolymers, etc. Also, polypropylenes made from homogeneous solution processes with single-site catalysts typically have narrow molecular weight and tacticity distributions. While narrow molecular weight distribution is preferable in some applications, it can be problematic in areas where high shear thinning is preferred for faster speeds and lower energy consumption during melt processing.

When compared to polypropylenes produced using Zeigler-Natta (ZN) catalysts in lower-temperature slurry or fluidized bed reactors, isotactic polypropylenes made from homogeneous solution processes with single-site catalysts are disadvantaged by their relatively low molecular weight and low tacticity and/or modulus. ZN-type catalysts, though not typically thought of as “supported”, perform heterogeneous polymerization. Single-site catalyzed polypropylenes generally exhibit less pronounced shear thinning behavior at high shear rates compared to multi-sited ZN-catalyzed polypropylenes. The difference in flow properties between single and multi-sited polypropylenes is generally attributed to the polypropylene's molecular weight distribution (MWD) (weight average molecular weight/number average molecular weight, or Mw/Mn) at a given melt flow rate (“MFR,” ASTM D1238, using 2.16 kg, 230° C. as used throughout). Single-sited polypropylenes made by solution polymerization using metallocene, or constraint-geometry, or other single-site homogeneous catalysts, typically have a MWD in the range of 2.0-2.5, whereas current multi-sited ZN-catalyzed polypropylenes in the industry typically display MWD values mostly in the range of 4.0-6.0. The higher MWD multi-sited polypropylenes generally exhibit higher levels of shear thinning, i.e., their viscosity drops more under shear, which is advantageous during processing such as injection molding. This is because such polypropylenes require less energy to pump during molding while they can have high viscosity, and thus can retain their molded shape once out of the high-shear zone of the fabrication process. The level of shear thinning also tends to have a pronounced effect on the stiffness of injection molded parts. This is believed to be a consequence of orientation frozen in injection molded parts due to unrelaxed chains with high molecular weight. Polypropylenes with broader distribution of molecular weights therefore are not only easier to process, but also provide injection molded parts with higher stiffness at given levels of tacticity.

In order to combine the catalyst and flexible product design advantages of solution processes using single-site catalysts with the better processibility of multi-site catalyzed polypropylenes, there is a need for single-site catalyzed polypropylenes with broader molecular weight distribution to achieve shear thinning properties that are preferably comparable to those of conventional ZN-catalyzed polypropylenes. The present invention provides a method for making advantageously tailored bimodal polypropylene compositions with excellent processibility (shear thinning) and high modulus using single-site (e.g., metallocene) catalysts in a solution polymerization process. The invention also provides for bimodal polypropylene compositions, preferably single-site catalyzed, having good shear thinning and mechanical strength properties. Further, in certain aspects of the invention the polypropylene components are advantageously combined while in solution during the polymerization process in-line, before the components are recovered in their solid (e.g., pelletized) form.

Related references include EP 2 426 171 A1; EP 2 014 715; EP 1 801 155 A1; US 2014/0121325; U.S. Pat. No. 9,321,914; U.S. Pat. No. 9,068,030; U.S. Pat. No. 8,410,230; U.S. Pat. No. 8,318,875; U.S. Pat. No. 8,058,371; U.S. Pat. No. 8,008,412; U.S. Pat. No. 7,939,610; and U.S. Pat. No. 7,812,104.

### SUMMARY OF THE INVENTION

The invention provides a method for making a polypropylene composition, preferably a bimodal polypropylene composition with high shear thinning and mechanical strength, in a solution process preferably using at least one single-site catalyst. In one aspect, the invention encompasses a method for making a bimodal polypropylene composition, comprising: (a) contacting in a first reactor propylene monomers with a first single-site catalyst in solution to form a first polypropylene having an MFR of 0.5 to 5 dg/min; (b) contacting in a second reactor propylene monomers with a second single-site catalyst in solution to form a second polypropylene having an MFR of 120 to 550 dg/min; (c) combining the first polypropylene and second polypropylene, preferably in a homogeneous solution phase in-line, to form a bimodal polypropylene composition, wherein the bimodal polypropylene composition has an MFR of 30 to 100 dg/min; and (d) recovering the bimodal polypropylene composition.

The invention also provides a bimodal polypropylene composition. In one aspect, the invention encompasses a bimodal polypropylene composition comprising: (a) a first polypropylene having an MFR of 0.5 to 5 dg/min; and (b) a second polypropylene having an MFR of 120 to 550 dg/min, wherein the bimodal polypropylene composition has an MFR of 30 to 100 dg/min, a flexural modulus of at least 1400 MPa, and a shear thinning index (200° C., complex viscosity @ 1E-02 rad/s/complex viscosity @ 1E+02 rad/s) of at least 2.

### DESCRIPTION OF THE FIGURES

FIG. 1 illustrates the melting temperature vs. MFR for the low-MFR (first polypropylene) and high-MFR (second polypropylene) components provided in Table 1 and 2.

FIG. 2 illustrates the dependence of MFR values on the composition of bimodal polypropylene compositions.

FIG. 3 illustrates complex viscosity dependence on angular frequency (shear thinning) for bimodal metallocene-catalyzed polypropylene, ZN-catalyzed polypropylene, and unimodal polypropylene.

### DETAILED DESCRIPTION

The invention provides for a broadening of molecular weight distribution of polypropylenes (preferably single-site catalyzed) made in solution processes via a bimodal polypropylene composition having a lower MFR component (the first polypropylene) and a higher MFR component (the second polypropylene), and methods for making such a composition. In particular, compositions of the invention are specially adjusted to preferably exhibit shear thinning similar to or better than that of conventional polypropylenes made in ZN-catalyzed slurry or gas-phase processes.

The invention provides a method for making a polypropylene composition, in particular a bimodal polypropylene composition, in a solution process. In one aspect, the invention encompasses a method for making a bimodal polypropylene composition, comprising: (a) contacting in a first reactor propylene monomers with a first single-site catalyst in solution to form a first polypropylene having an MFR of 0.5 to 5 dg/min; (b) contacting in a second reactor propylene monomers with a second single-site catalyst (which can be the same or different from the first single-site catalyst) in solution to form a second polypropylene having an MFR of 120 to 550 dg/min; (c) combining the first polypropylene and second polypropylene to form a bimodal polypropylene composition, wherein the bimodal polypropylene composition has an MFR of 30 to 100 dg/min; and (d) recovering the bimodal polypropylene composition.

The invention also provides a bimodal polypropylene composition. In one aspect, the invention encompasses a bimodal polypropylene composition comprising: (a) a first polypropylene having an MFR of 0.5 to 5 dg/min; and (b) a second polypropylene having an MFR of 120 to 550 dg/min, wherein the bimodal polypropylene composition has an MFR of 30 to 100 dg/min, a flexural modulus of at least 1400 MPa, and a shear thinning index (200° C., complex viscosity @ 1E-02 rad/s/complex viscosity @ 1E+02 rad/s) of at least 2.

### Polypropylene

As used herein, the term “polypropylene” refers to one or a combination of propylene-based polymers comprising at least 60 wt %, preferably at least 80 wt %, more preferably at least 90, or 100 wt %, propylene-derived units (by weight of the propylene-based polymer(s)), or a composition comprising propylene-based polymers having a total content of at least 60 wt %, preferably at least 80 wt %, more preferably at least 90, or 100 wt %, propylene-derived units. Examples of “polypropylene” include polypropylene homopolymers, propylene copolymers, and the like. Preferably, “polypropylene” refers to polypropylene homopolymers such as isotactic polypropylene homopolymer.

The polypropylene compositions of the invention are preferably bimodal. A bimodal polypropylene composition includes at least two polypropylene components, i.e., a first polypropylene and a second polypropylene. By “bimodal,” what is meant is that there is a spread (or difference) in MFR between the first polypropylene and second polypropylene of at least 10 or 20 g/10 min, or a difference in the Mw by at least 5,000 or 10,000 g/mole, which may be seen on a GPC plot as a typical bell-shaped curve with a “bump” or “shoulder” or two distinct bell-shaped curves, and shapes there between.

The first polypropylene has a lower MFR than the second polypropylene. Preferably, the first polypropylene has an MFR of 0.5 to 5 dg/min, more preferably 0.8 to 2 dg/min, or 1 to 1.5 dg/min, and more preferably 1 dg/min.

In certain embodiments, the first polypropylene has a weight average molecular weight (Mw) of from 200,000 to 600,000 g/mol, preferably from 250,000 to 500,000 g/mol, and more preferably from 350,000 to 450,000 g/mol. The first polypropylene can have a number average molecular weight (Mn) of from 100,000 to 200,000 g/mol, preferably from 150,000 to 200,000 g/mol; and more preferably from 160,000 to 180,000 g/mol.

In certain embodiments, the first polypropylene has a branching index (g′ᵥᵢₛ) of more than 1.0, preferably from 1.02 to 1.04. Branching index can be measured as described in U.S. Pat. No. 6,870,010.

The second polypropylene has a higher MFR than the first polypropylene. Preferably, the second polypropylene has an MFR of 120 to 550 dg/min, more preferably 150 to 400 dg/min, or 200 to 400 dg/min, and more preferably 200 to 300 dg/min, and even more preferably 300 dg/min.

In certain embodiments, the second polypropylene has a weight average molecular weight (Mw) of from 50,000 to 300,000 g/mol, preferably from 75,000 to 200,000 g/mol, and more preferably from 80,000 to 150,000 g/mol. The second polypropylene can have a number average molecular weight (Mn) of from 20,000 to 100,000 g/mol, preferably from 30,000 to 75,000 g/mol; and more preferably from 40,000 to 60,000 g/mol.

In certain embodiments, the second polypropylene has a branching index (g′ᵥᵢₛ) of less than 1.0, preferably from 0.92 to 0.97, or from 0.93 to 0.96.

Polypropylenes useful herein, such as the first polypropylene and/or the second polypropylene, preferably have a heat of crystallization (ΔHc) (DSC, ASTM D3418) of at 80 J/g or more, or within the range of from 80, or 85, or 90, or 100 J/g to 125, or 130, or 135 J/g; and a crystallization temperature (Tc) within the range of from 100, or 110, or 115, or 120° C. to 130, or 135, or 140, or 145, or 150, or 155, or 160, or 165, or 170° C. In certain embodiments, the first and/or second polypropylene preferably has a melting point (Tm, DSC, ASTM D3418) of greater than 150 or 155° C.; or within a range of from 150° C. to 155, or 160, or 165, or 170° C. Preferably, the first and/or second polypropylene has a peak melting temperature greater than 150° C., or greater than 153° C., or greater than 155° C. Further details for ΔHc, Tm, and Tc measurement methods, including heating rate, cooling rate, and melting temperature measurement, are according to the Examples, “DSC Analysis” section.

In certain embodiments, the first and/or second polypropylene comprises isotactic propylene homopolymers, preferably made in a homogeneous solution process using single-site catalysts, like metallocenes or constrained geometry catalysts, or the like. Preferably, at least one isotactic propylene homopolymer has less than 100 regio defects (sum of 2,1-erythro and 3,1-isomerizations) per 10,000 propylene units. In some embodiments, the first and/or second polypropylene has an mmmm propylene pentad fraction of 0.85 or more, 0.87 or more, 0.9 or more, 0.92 or more, 0.93 or more, 0.94 or more, 0.95 or more, or 0.96 or more. The NMR method used for determining mmmm polypropylene tacticity is described in detail in U.S. Pat. No. 7,807,769, as based on the description by L. Resconi, L. Cavallo, A. Fiat, F. Piemontesi, 100 CHEM. REV. 1253-1345 (2000).

### Bimodal Polypropylene Composition

The invention encompasses bimodal polypropylene compositions, including those made by the polymerization processes described herein.

The bimodal polypropylene composition comprises a first polypropylene and a second polypropylene. The bimodal polypropylene composition preferably has an MFR of 30 to 100 dg/min, preferably 35 to 70 dg/min. In a preferred embodiment, the bimodal composition comprises a first polypropylene having an MFR of 1 dg/min, and a second polypropylene having an MFR of 300 dg/min.

In certain embodiments, the bimodal polypropylene composition has a flexural modulus of at least 1400 MPa, preferably at least 1501 MPa, and more preferably at least 1600 MPa.

In some embodiments, the bimodal composition preferably contains a first polypropylene in an amount of at least 50%, or at least 60%, or at least 70% by weight, based on the total weight of the first polypropylene and the second polypropylene. In certain preferred embodiments, the first polypropylene is present in amount of 55% to 70%, and more preferably 60% to 65% by weight. In some preferred embodiments, the first polypropylene is present in an amount of 65% to 75%, more preferably 60% to 65% by weight.

In some embodiments, the bimodal composition preferably contains a second polypropylene in an amount of less than 45 wt %, preferably 35 to 45 wt %, based on the total weight of the first polypropylene and the second polypropylene. In certain preferred embodiments, the second polypropylene is present in amount of less than 40 wt %, preferably 35 to 40 wt %.

In some preferred embodiments, the bimodal composition comprises 60 to 65 wt % of the first polypropylene, and 35 to 40 wt % of the second polypropylene, based on the total weight of the first polypropylene and the second polypropylene. In certain preferred embodiments, the bimodal composition comprises 70 to 75 wt % of the first polypropylene, and 25 to 30 wt % of the second polypropylene, based on the total weight of the first polypropylene and the second polypropylene.

In certain embodiments, the bimodal polypropylene composition has a shear thinning index (200° C., complex viscosity @ 1E-02 rad/s/complex viscosity @ 1E+02 rad/s) of at least 2, preferably at least 3.5, and more preferably at least 4.

The bimodal polypropylene composition can be combined with any other polymers or components.

### Catalysts and Activators

As used herein and for ease of reference, unless otherwise specified, a “catalyst” refers to those in its active form, and further includes catalyst precursors which, when combined with an activator, are activated to act as a catalyst.

As used herein, a “Ziegler-Natta” catalyst is defined as a transition metal compound bearing a metal-carbon bond—excluding cyclopentadienyls or ligands isolobal to cyclopentadienyl—and able to carry out a repeated insertion of olefin units. Definitions and examples of Ziegler-Natta catalyst used for propylene polymers can be found in Chapter 2 of “Polypropylene Handbook” by Nello Pasquini, 2^{nd} Edition, Carl Hansen Verlag, Munich 2005. Examples of Ziegler-Natta catalysts include first and second generation TiCl₂ based, the MgCl₂ supported catalysts as described in the “Polypropylene Handbook” by N. Pasquini. The polypropylenes useful herein may be made using Ziegler-Natta catalysts.

As used herein, “metallocene catalyst” means a Group 4 or 5 transition metal compound having at least one cyclopentadienyl, indenyl or fluorenyl group attached thereto, or ligand isolobal to those ligands, that is capable of initiating olefin catalysis, typically in combination with an activator. Definitions and examples of metallocene catalysts can be found in Chapter 2 of “Polypropylene Handbook” by Nello Pasquini, 2^{nd} Edition, Carl Hansen Verlag, Munich, 2005. The polypropylenes and α-olefin copolymers may be produced in any embodiment using such catalysts.

Heterogeneous Ziegler-Natta and homogeneous single-site catalysts are also described in Chapter 2, of the “Polymerization Handbook”, E. P. Moore, Jr Ed., Hanser, New York, 1996 (ISBN 1-56990-208-9).

As used herein, “single-site catalyst” means a Group 4 through 10 transition metal compound that is capable of initiating olefin polymerization, such as metallocenes, diimine-ligated Ni and Pd complexes; pyridinediimine-ligated Fe complexes; pyridylamine-ligated Hf complexes (e.g., US 2014/0256893, and US 2014/0316089); and bis(phenoxyimine)-ligated Ti, Zr, and Hf complexes. Additional examples of single-site catalysts are described in G. H. Hlatky “Heterogeneous Single-Site Catalysts for Olefin Polymerization,” 100 Chem. Rev., 1347-1376, (2000); K. Press, A. Cohen, I. Goldberg, V. Venditto, M. Mazzeo, M. Kol, “Salalen Titanium Complexes in the Highly Isospecific Polymerization of 1-Hexene and Propylene,” in 50 Angew. Chem. Int. Ed., 3529-3532, (2011); and “Stereoselective Polymerization with Single-Site Catalysts,” by L. S. Baugh and J. M. Canich, CRC Press, New York, 2008 (ISBN-13: 978-1-57444-579-4); and references therein. Examples of single-site catalysts include complexes containing tert-butyl-substituted phenolates ([Lig1-3TiBn₂]), complex [Lig4TiBn₂] featuring the bulky adamantyl group, the sterically unhindered complex [Lig5TiBn₂]. Single-site catalysts include metallocene catalysts such as those described herein.

In certain embodiments, the bimodal polypropylene composition is made by contacting in a first reactor propylene monomers with a first single-site catalyst (e.g., in the form of a catalyst precursor) in solution to form a first polypropylene, contacting in a second reactor propylene monomers with a second single-site catalyst (e.g., in the form of a catalyst precursor) in solution to form a second polypropylene, combining the first polypropylene and second polypropylene to form the bimodal polypropylene composition. Preferably, the first and/or second single-site catalysts are metallocene catalysts.

Active single-site catalysts such as metallocene catalysts are preferably formed by contacting a catalyst precursor and an activator. Since an activated catalyst is typically less stable than its catalyst precursor, the contacting of the catalyst precursor and the activator to form the active catalyst is typically performed in the polymerization plant just prior to using the active catalyst to make the polymer. The contacting of the catalyst precursor and the activator may be carried out upstream of the reactor, that is prior to feeding them to the reactor in the catalyst feed line or in dedicated catalyst vessels. However, in some instances the contacting of the catalyst precursor and the activator may also be carried out in the polymerization reactor itself. This latter method is particularly suitable when the residence time in the reactor is longer than the time required to fully convert the catalyst precursor to its active catalyst form.

The first single-site catalyst and the second single-site catalyst may be the same or different. In some embodiments, the first single-site catalyst and/or second single-site catalyst are metallocenes, preferably catalysts (in the form of precursors) selected from organometallic compounds of the following general structure:

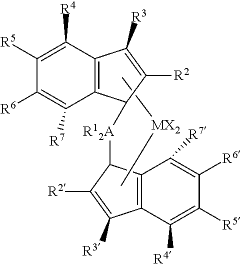

where M is a Group 4 metal, preferably hafnium or zirconium; each X is a halogen or C₁ to C₁₀ alkyl; A is a tetravalent atom, preferably silicon or carbon; each R¹ is independently selected from hydrogen and C₁ to C₁₀ alkyls; each of R⁴ and R^{4′} is selected from substituents such as optionally substituted phenyl or naphthyl groups, or heterocyclic aromatic hydrocarbon groups, for example, nitrogen containing aromatic groups, preferably C₁₀ to C₂₀ nitrogen containing aromatic groups, wherein the C₁₀ to C₂₀ nitrogen containing aromatic group is bound to the 4 and 4′ indenyl carbons through the heteroatom, which is advantageously nitrogen; and each of R², R³, R⁵, R⁶, R⁷, R^{2′}, R^{3′}, R^{5′}, R^{6′}, and R^{7′} is selected from hydrogen and C₁ to C₁₀ alkyls.

In some embodiments, the first single-site catalyst is dimethyl (μ-dimethylsilyl)bis(2-methyl-4-(N-carbazolyl)indenyl)zirconium. In certain embodiments, the second single-site catalyst is dimethyl (μ-dimethylsilyl)bis(2-methyl-4-(3′5′-di-tert-butylphenyl)indenyl)zirconium.

In some embodiments, the first and second single-site catalysts are the same. In such embodiments, the second reactor preferably further comprises a chain transfer agent, for example hydrogen. Advantageously, the first catalyst and the second catalyst in such embodiments are both dimethyl (μ-dimethylsilyl)bis(2-methyl-4-(N-carbazolyl)indenyl)zirconium, and preferably the chain transfer agent is hydrogen.

The first single-site catalyst and/or second single-site catalyst (e.g., in their precursor forms), may be combined with an activator (or more than one activator, which could be the same or different). An activator is any combination of reagents that increases the rate at which a metal complex polymerizes unsaturated monomers, such as olefins, particularly propylene.

Activators may include aluminoxane and aluminum alkyl compounds. Aluminoxanes, sometimes called alumoxanes in the art, are generally oligomeric Al compounds containing —Al(R)—O— subunits, where R is an alkyl group. Examples of aluminoxanes include methylaluminoxane (MAO), modified methylaluminoxane (MMAO), ethylaluminoxane and isobutylaluminoxane. Alkylaluminoxanes and modified alkylaluminoxanes are suitable as catalyst activators, particularly when the abstractable ligand of the catalyst precursor is a halide. Mixtures of different aluminoxanes and modified aluminoxanes can also be used.

Activators may also include ionizing activators, also referred to as non-coordinating anion activators (NCAs). Examples include an ionizing or stoichiometric activator, such as tri(n-butyl)ammonium tetrakis(pentafluorophenyl)-borate, a trisperfluorophenyl boron metalloid precursor or a trisperfluoro-naphthyl boron metalloid precursor, polyhalogenated heteroborane anions (WO 98/43983), boric acid (U.S. Pat. No. 5,942,459) or combination thereof as an activator herein. Other examples include NCA activators alone or in combination with aluminoxane or modified aluminoxane activators. Examples of NCA activators include tri-substituted boron, aluminum, gallium and indium compounds or mixtures thereof. The three substituent groups are each independently selected from alkyls, alkenyls, halogen, substituted alkyls, aryls, arylhalides, alkoxy and halides. The three groups are independently selected from halogen, mono or multicyclic (including halosubstituted) aryls, alkyls, and alkenyl compounds and mixtures thereof, advantageous are alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls). Alternately, the three groups are alkyls having 1 to 4 carbon groups, phenyl, naphthyl or mixtures thereof. Alternately, the three groups are halogenated, advantageously fluorinated, aryl groups. Alternately, the NCA is trisperfluorophenyl boron or trisperfluoronaphthyl boron. Other NCA activator compounds may contain an active proton, or some other cation associated with, but not coordinated to, or only loosely coordinated to, the remaining ion of the NCA compound.

Activators may also include non-ionizing activators. Activators are typically strong Lewis-acids which can play either the role of ionizing or non-ionizing activator. Activators previously described as ionizing activators can also be used as non-ionizing activators. Abstraction of formal neutral ligands can be achieved with Lewis-acids that display an affinity for the formal neutral ligands. These Lewis-acids are typically unsaturated or weakly coordinated. Non-ionizing activators also include weakly coordinated transition metal compounds such as low valent olefin complexes.

In some embodiments, the first metallocene catalyst (e.g., in its precursor form) is combined with an activator. Advantageously, the first metallocene catalyst is combined with dimethylaniliniumtetrakis(heptafluoronaphthyl)borate.

In some embodiments, the second metallocene catalyst (e.g., in its precursor form) is combined with an activator. Advantageously, the second metallocene catalyst is combined with dimethylaniliniumtetrakis(perfluorophenyl)borate or with dimethylaniliniumtetrakis(heptafluoronaphthyl)borate.

### Polymerization Process

In one aspect, the invention encompasses a method for making a bimodal polypropylene composition in a solution process, comprising: (a) contacting in a first reactor propylene monomer with a first single-suite (preferably metallocene) catalyst in solution to form a first polypropylene; (b) contacting in a second reactor propylene monomers with a second metallocene catalyst in solution to form a second polypropylene; (c) combining the first polypropylene and second polypropylene to form a bimodal polypropylene composition; and (d) recovering the bimodal polypropylene composition. In certain preferred embodiments, the first polypropylene and second polypropylene are combined in solution, or in “in situ”, prior to being pelletized. The invention also encompasses bimodal polypropylene compositions made thereby. Preferably, at least one of the first polypropylene and the second polypropylene are isotactic. Preferably, the bimodal polypropylene composition is isotactic. Further details for making the bimodal polypropylene composition are provided as follows.

As used herein, “solution process” for making a polymer refers to a homogeneous polymerization process in which the catalyst and the polymer product are dissolved in a liquid polymerization system comprising an inert solvent and the monomer(s). In general terms, the monomer may also be used to act as a solvent without an inert solvent added to the polymerization system. In the processes of the present disclosure, the monomer is a light hydrocarbon, thus the polymerization system advantageously includes an inert solvent to keep the system homogeneous at lower reactor pressures than what is needed without the use of an inert solvent. Solution polymerization comprises a homogeneous liquid polymerization system in the reactor, meaning that the polymer product is dissolved and molecularly dispersed in the polymerization system. The temperature of a liquid polymerization system is typically below its supercritical or pseudo supercritical temperature, thus solution polymerizations are preferably performed below the supercritical temperature of the polymerization system.

The first reactor and the second reactor may have the same, different, or overlapping reaction conditions such as temperature, pressure, solvents, feed rates, etc. In certain embodiments, the temperature in at least one of the first and second reactors is 90 to 160° C., advantageously 95 to 125° C., or 95 to 120° C., or 98 to 115° C., or 98 to 110° C.

In some embodiments, the pressure in at least one of the first and second reactors is 3.5 to 34.5 MPa, advantageously 5 to 25 MPa, or 7.5 to 15 MPa, or 9 to 14 MPa.

Advantageously, the bimodal polypropylene compositions of the present disclosure are made in a homogeneous polymerization process. A homogeneous polymerization system contains all of its components in a single phase dispersed and mixed on a molecular scale. Homogeneous polymerization systems are meant to be in their dense fluid (liquid or supercritical) state. The polymerization system as used herein does not include the catalyst system, thus the catalyst system may or may not be homogeneously dissolved in the polymerization system. Advantageously, the catalyst system of the present disclosure is also homogeneously dissolved in the polymerization system.

A homogeneous system may have regions with concentration gradients, but there would be no sudden, discontinuous changes of composition on a micrometer scale within the system as it is the case when, for example, solid polymer-containing particles are suspended in a dense fluid. In practical terms, a homogeneous polymerization system has all of its components in a single dense fluid phase. A polymerization system is not considered homogeneous when it is partitioned to more than one fluid phase or to a fluid and a solid phase, the latter comprising at least a part of the polymer product. The homogeneous fluid state of the polymerization system is represented by the single fluid (liquid or supercritical fluid) region in its phase diagram. Advantageously, the homogeneous polymerization systems in the processes of the present disclosure are their liquid state, i.e., below their critical or pseudo-critical temperatures.

Advantageously, the bimodal polypropylene compositions of the present disclosure are made in a continuous polymerization process. A “continuous process” refers to a system that operates without interruption or cessation. A continuous process to produce a polymer is one where the reactants are continually introduced into one or more reactors and the polymer product (in the present disclosure characterized by a bimodal molecular weight composition) is continually withdrawn.

The first reactor and the second reactor may be in series or in parallel configurations, and there may be additional reactors in combination therewith.

All documents described herein are incorporated by reference herein in their entirety unless otherwise stated. The various descriptive elements and numerical ranges disclosed herein for the inventive methods and compositions can be combined with other descriptive elements and numerical ranges to describe the invention(s); further, for a given element, any upper numerical limit can be combined with any lower numerical limit described herein, including the examples. Terms such as “preferably” and “advantageously” are exemplary and non-limiting to the scope of the invention. The features of the inventions are demonstrated in the following non-limiting examples.

### EXAMPLES

Below are examples to illustrate certain embodiments of the invention. As is apparent from the foregoing general description and the specific embodiments, while forms of the invention have been illustrated and described, various modifications can be made without departing from the spirit and scope of the invention. Accordingly, it is not intended that the invention be limited thereby.

### Polymerization

Polymerization was performed in a continuous stirred tank reactor (CSTR) made by Autoclave Engineers, Erie Pa. The nominal reactor vessel volume was 150 or 300 mL. The reactor was equipped with a magnetically coupled mechanical stirrer (Magnedrive). A pressure transducer measured the pressure in the reactor. The reactor temperature was measured using two type-K thermocouples, and the reported values are the averages of the two readings. A flush-mounted rupture disk located on the side of the reactor provided protection against catastrophic pressure failure. Product lines were heated to 120° C. to prevent fouling. The reactor had an electric heating band that was controlled by a programmable logic control (PLC) computer. Except for the heat losses to the environment, the reactor did not have cooling (semi-adiabatic operations).

The conversion in the reactor was monitored by an on-line gas chromatograph (GC) that sampled both the feed and the effluent. The GC analysis utilized the propane impurity present in the propylene feed as internal standard. The target reactor temperature was typically maintained at 0.1-0.6 mol ppm catalyst concentrations in the feed. Feed purification traps were used to control impurities carried by the monomer feed. The purification traps were placed right before the feed pumps and comprised of two separate beds in series: activated copper (reduced in flowing H₂ at 225° C. and 1 bar) for O₂ removal followed by a molecular sieve (5 A, activated in flowing N₂ at 270° C.) for water removal.

Propylene was fed from a low-pressure cylinder equipped with a dip leg for liquid delivery to the reactor. The catalyst feed solution was prepared inside an argon-filled dry box (Vacuum Atmospheres). Stock solutions of the catalyst precursor and the activator were prepared using purified toluene.

HPLC grade hexane (95% n-hexane, J. T. Baker) was used as solvent. It was purged with Argon for a minimum of four hours and was sent through an activated copper and a molecular sieve (5 A) bed, then filtered once over activated basic alumina. The filtered hexane was delivered to the reactor by a two-barrel continuous ISCO pump (model 500D).

The products were collected and weighed after vacuum-drying overnight at 70° C. Aliquots of the product were used for characterization without homogenizing the entire product yield.

### DSC Analysis

The heat associated with phase transitions were measured on heating and cooling the polymer samples from the solid state and melt, respectively, using a TA Instruments Discovery series DSC. The data were analyzed using the analysis software provided by the vendor. Typically, 3 to 10 mg of polymer was placed in an aluminum pan and loaded into the instrument at room temperature. The sample was cooled to −40° C. and then heated to 210° C. at a heating rate of 10° C./min to evaluate the glass transition and melting behavior for the as-received polymers. Crystallization behavior was evaluated by cooling the sample from 210° C. to −40° C. at a cooling rate of 10° C./min. Second heating data were measured by heating this melt-crystallized sample at 10° C./min. The second heating data thus provide phase behavior information for samples crystallized under controlled thermal history. The endothermic melting transition (first and second melt) and exothermic crystallization transition were analyzed for onset of transition and peak temperature. The melting temperatures are the peak melting temperatures from the second melt unless otherwise indicated. For polymers displaying multiple peaks, the higher melting peak temperatures are reported. Glass transition temperature values are defined by the temperature at which the heat capacity change (Δcₚ) is half of its total value (step-change between equilibrium liquid to equilibrium solid state) at which point half of the sample is de-vitrified. Areas under the DSC curve were used to determine the heat of fusion (ΔH_{f}).

### Melt Flow Rate (MFR)

The Melt Flow Rates (MFR) of polymers were determined by using Dynisco Kayeness Polymer Test Systems Series 4003 apparatus following ASTM D1238 and ISO 1133 methods.

### Solution Blending

Prior to the blending, appropriate amount of low and high MFR polypropylenes were put into a beaker containing magnetic stirrer and xylene to provide polymer concentration 10-15 wt %. 1000 ppm of Irganox 1010 and 1000 ppm Irgafos 168 (calculated per mass of polypropylene) was added to minimize thermooxidation during the blending and following drying. Solution blending was done at a temperature 130° C. After dissolving all polypropylene solids the solution was continuously stirred for another 30 min at 130° C. and then cooled slowly to room temperature. Solvent removal was done in vacuum oven at a temperature 80° C.

### Shear Rheology

Shear rheology was characterized using ARES G2 rheometer (TA Instruments) at 200° C. and small amplitude oscillations (0.01% shear strain). Frequency range 0.01-100 Hz was probed.

### Flexural Modulus

ISO 37 Type 3 micro-dogbone specimens were used for determination of 1% Sec Flex modulus. A crosshead speed of 1 mm/min (0.0394 in/min), and a span/thickness ratio of 15 provided was used, resulting in data in line with ASTM numbers.

Table 1 shows exemplary first polypropylenes of the invention and process conditions for making them. Table 2 shows exemplary second polypropylenes of the invention and process conditions for making them.

TABLE 1
Samples prepared for demonstrating low-MFR polypropylene (first polypropylene)

| | Reactor Conditions | | | | | Product | | | | | | | | |
|---|---|---|---|---|---|---|---|---|---|---|---|---|---|---|
| | | | C₃⁼ feed (solvent | | C₃⁼ | | Crystallization | | Melting (second) | | | LS | DRI | |
| | Temp | Pressure | included) | | conv. | MFR | Onset | Peak | Onset | Peak | ΔH_{f} | Mw | Mn | VIS |
| Sample # | ° C. | Psig | g/min | wt % | % | g/10 min | ° C. | ° C. | ° C. | ° C. | J/g | kg/mol | kg/mol | g′ |
| Sample 1 | 101 | 1636 | 5.09 | 34.8 | 26.8 | 1.7 | 119.9 | 115.7 | 151.8 | 159.9 | 102.3 | 427.8 | 169.8 | 1.03 |
| Sample 2 | 101 | 1677 | 5.15 | 35.2 | 25.7 | 1.6 | 116.6 | 114.6 | 152.6 | 158.3 | 102.7 | 407.2 | 157.7 | 1.02 |
| Sample 3 | 101 | 1607 | 5.15 | 35.3 | 24.9 | 1.1 | 122.7 | 119.5 | 153.8 | 158.6 | 105.3 | 399.9 | 168.2 | 1.02 |
| Sample 4 | 101 | 1677 | 5.15 | 35.2 | 27.8 | 1.3 | 116.4 | 114.2 | 152.1 | 157.8 | 101.8 | 440.2 | 172.4 | 1.03 |
| Sample 5 | 100 | 1726 | 5.15 | 35.2 | 26.3 | 0.8 | 119.7 | 115.4 | 152.9 | 158.3 | 103.7 | 451.1 | 175.2 | 1.03 |
| Sample 6 | 101 | 1648 | 5.14 | 35.1 | 24.2 | 1.5 | 118.0 | 113.6 | 148.8 | 161.9 | 100.5 | 438.5 | 168.2 | 1.03 |
| Sample 7 | 102 | 1653 | 5.14 | 35.2 | 25.9 | 1.5 | 119.6 | 115.8 | 153.0 | 157.0 | 100.7 | 459.7 | 182.0 | 1.04 |
| Sample 8 | 101 | 1618 | 5.14 | 34.9 | 24.7 | 1.2 | 118.5 | 114.9 | 152.4 | 157.9 | 101.5 | 459.1 | 182.1 | 1.03 |
| Sample 9 | 102 | 1614 | 5.14 | 34.8 | 26.5 | 1.5 | 117.0 | 113.2 | 152.3 | 157.0 | 100.5 | 393.7 | 159.6 | 1.02 |

Activator/catalyst: dimethylaniliniumtertrakis(heptafluoronapthyl)borate-activated dimethyl (μ-dimethyslsilyl)bis(2-methyl-4-(N-carbazolyl)indenyl)zirconium
Scavenger: 11 mol ppm Al(n-octyl)₃
Solvent: n-Hexane

TABLE 2
Samples prepared for demonstrating high-MFR polypropylene (second polypropylene)

| | Reactor Conditions | | | | | Product | | | | | | | | |
|---|---|---|---|---|---|---|---|---|---|---|---|---|---|---|
| | | | C3= feed | | | | Crystal- | | | | | | | |
| | | | (solvent | | C3 = | | lization | | Melting (second) | | | LS | DRI | |
| | Temp | Pressure | included) | | conv. | MFR | Onset | Peak | Onset | Peak | ΔH_{f} | Mw | Mn | VIS |
| Sample # | ° C. | psig | g/min | wt % | % | g/10 min | ° C. | ° C. | ° C. | ° C. | J/g | kg/mol | kg/mol | g′ |
| Sample A | 100 | 1567 | 4.98 | 22.6 | 54.0 | 129 | 115.8 | 113.0 | ** | 156.7 | 102.1 | 130.4 | 60.2 | 0.97 |
| Sample B | 99 | 1587 | 3.30 | 20.6 | 64.5 | 185 | 116.4 | 113.8 | 151.8 | 154.6 | 109.6 | 108.5 | 45.1 | 0.95 |
| Sample C | 102 | 1593 | 4.49 | 20.8 | 57.1 | 197 | 117.5 | 113.2 | ** | 156.2 | 108.0 | ** | ** | ** |
| Sample D | 100 | 1591 | 3.30 | 20.6 | 66.0 | 214 | 116.2 | 113.8 | 151.8 | 153.9 | 107.1 | 110.4 | 40.5 | 0.94 |
| Sample E | 100 | 1601 | 3.31 | 20.8 | 60.3 | 217 | 116.8 | 114.7 | 151.9 | 155.0 | 109.5 | 115.9 | 49.2 | 0.97 |
| Sample F | 100 | 1646 | 3.30 | 20.6 | 68.1 | 221 | 116.6 | 115.2 | 151.5 | 154.3 | 107.3 | 104.3 | 44.8 | 0.96 |
| Sample G | 100 | 1651 | 3.30 | 20.6 | 74.8 | 226 | 115.8 | 113.4 | 151.3 | 154.0 | 106.2 | 109.8 | 45.6 | 0.96 |
| Sample H | 101 | 1635 | 3.30 | 20.5 | 69.7 | 230 | 116.3 | 114.3 | 151.7 | 155.0 | 108.8 | 106.6 | 43.1 | 0.96 |
| Sample I | 100 | 1643 | 3.30 | 20.5 | 75.5 | 238 | 117.1 | 114.7 | 151.4 | 154.2 | 108.8 | 98.5 | 34.9 | 0.94 |
| Sample J | 103 | 1613 | 4.50 | 20.8 | 60.2 | 265 | 116.4 | 114.0 | ** | 156.1 | 109.3 | ** | ** | ** |
| Sample K | 100 | 1637 | 3.30 | 20.5 | 73.9 | 295 | 116.7 | 115.4 | 151.7 | 153.9 | 108.6 | 98.3 | 40.6 | 0.95 |
| Sample L | 102 | 1644 | 4.50 | 20.4 | 65.3 | 307 | 118.7 | 116.4 | ** | 155.5 | 110.0 | 103.8 | 48.3 | 0.95 |
| Sample M | 102 | 1630 | 4.49 | 20.6 | 62.7 | 339 | 115.8 | 113.8 | ** | 155.1 | 109.8 | 99.1 | 48.4 | 0.95 |
| Sample N | 102 | 1613 | 4.49 | 20.7 | 65.5 | 342 | 116.4 | 114.6 | ** | 155.6 | 108.9 | 103.6 | 48.7 | 0.96 |
| Sample O | 100 | 1605 | 3.31 | 20.0 | 76.4 | 441 | 115.6 | 112.6 | 149.9 | 155.3 | 108.4 | 95.4 | 38.2 | 0.94 |
| Sample P | 100 | 1607 | 3.30 | 19.9 | 76.7 | 553 | 115.8 | 113.4 | 149.9 | 155.4 | 107.2 | 87.8 | 36.9 | 0.93 |

** Not measured
Activator/catalyst: dimethylaniliniumtertrakis(heptafluoronapthyl)borate-activated dimethyl (μ-dimethyslsilyl)bis(2-methyl-4-(N-carbazolyl)indenyl)zirconium
Scavenger: 11 mol ppm Al(n-octyl)₃

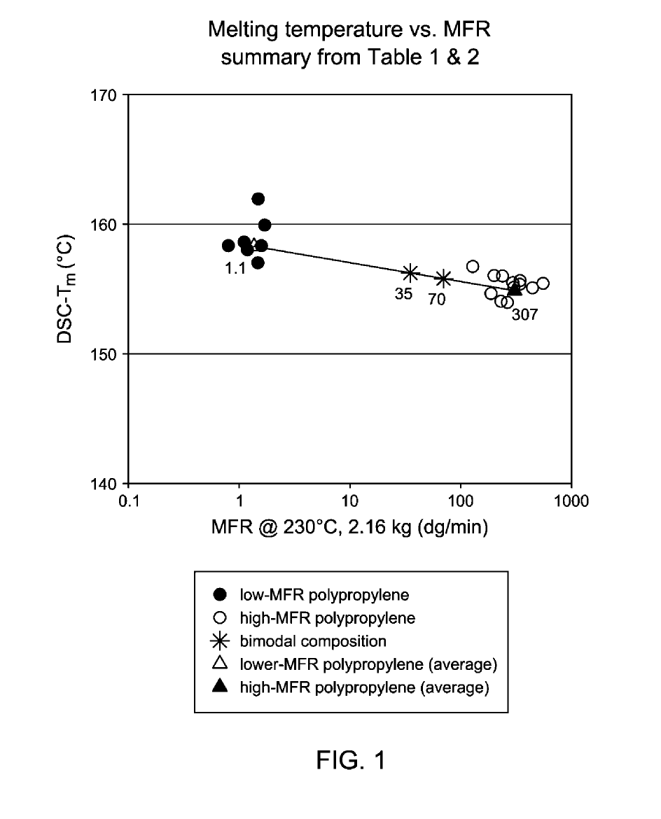

Data from Table 1 and 2 are summarized in FIG. 1. Two types of polypropylenes were prepared. The low-MFR polypropylene (Samples 1-9) were combined to form a first polypropylene having an average MFR of around 1.1 dg/min. The high-MFR polypropylene (Samples A-P) were combined to form a second polypropylene having an average MFR around 307 dg/min. The first polypropylene and second polypropylene were solution blended to form a bimodal blend. The target MFR values for bimodal blends were 35 and 70 dg/min, which correspond generally to those useful in injection molding grades for the automotive industry. The objective was to prepare compositions meeting the target MFR values and deliver rheology that is typical for conventional Ziegler-Natta polypropylenes. In preferred embodiments of the invention, the first polypropylene and second polypropylene are combined in a solution phase in-line during the polymerization process to form a bimodal blend.

The bimodal blend compositions contain approximately to 39-37 wt % and 27-25 wt % of a low MFR component (first polypropylene, MFR=˜1.1 dg/min), and 61-63 wt % and 73-75 wt % of a high MFR component (second polypropylene, MFR=˜307 dg/min), respectively, as shown below. Weight percentages are based on the total weight of the first polypropylene and the second polypropylene.

| | First | Second |
|---|---|---|
| | polypropylene | polypropylene |
| | (wt %) | (wt %) |
| | MFR ~1.1 dg/min | MFR ~307 dg/min |
| Bimodal polypropylene MFR 35 | 39-37 | 61-63 |
| Bimodal polypropylene MFR 70 | 27-25 | 73-75 |

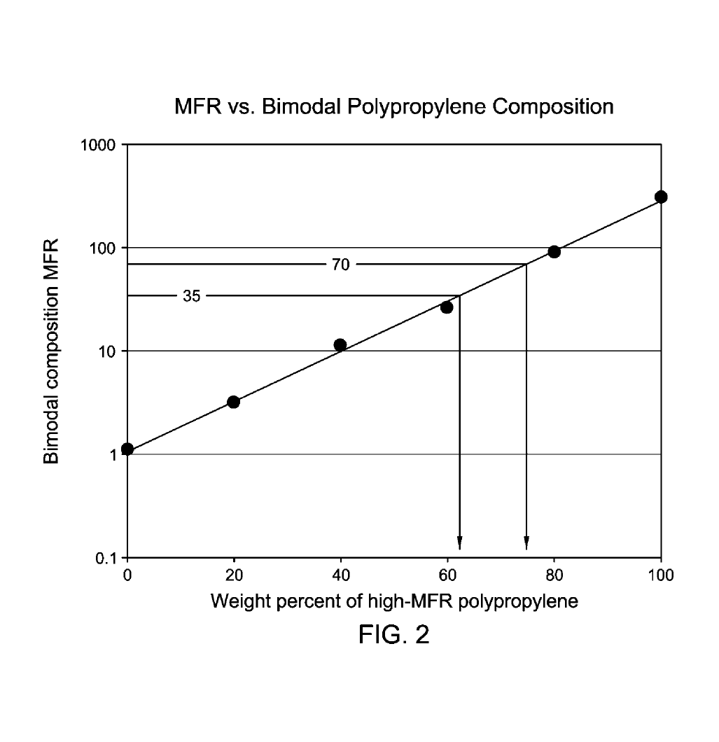

FIG. 2 illustrates MFR dependence on the composition of a bimodal polypropylene composition. This figure shows MFR of a bimodal composition as a function of the wt % of the high MFR component (second polypropylene) based on based on the total weight of the first polypropylene and the second polypropylene. The dependence is similar to an exponential relationship (linear in a semi-log plot).

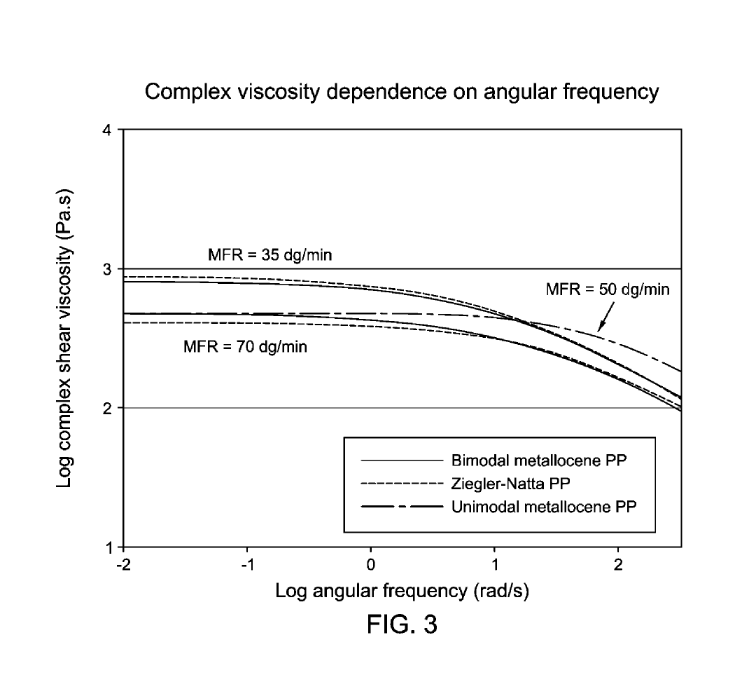

FIG. 3 demonstrates the effect of combining a first polypropylene (MFR=˜1 dg/min) and a second polypropylene (MFR=˜300 dg/min) into a bimodal polypropylene composition of the invention on shear rheology, namely shear thinning. The bimodal polypropylene composition, which contains metallocene-catalyzed polypropylene, displayed rheologies comparable to those of conventional Ziegler-Natta polypropylenes at given values of MFR. A shear rheology curve for unimodal solution metallocene polypropylene with MFR=50 dg/min is included for comparison. Such curve demonstrates the difference between rheologies of unimodal and bimodal solution metallocene polypropylenes. Unimodal metallocene polypropylene displays Newtonian behavior until considerably higher shear rates, as well as higher shear viscosity in the high shear rate region (shear rates typical of melt processing procedures such as extrusion or injection molding). On the other hand, the bimodal polypropylene composition containing metallocene-catalyzed polypropylene exhibited pronounced shear thinning at lower shear rates similar to Ziegler-Natta polypropylenes, which is desirable for high rate processing operations (mainly injection molding).

Table 3 shows that shear thinning has a positive impact on solid state properties such as flexural modulus. The bimodal polypropylene compositions of the invention (MFR 35, 70) display the flexural moduli comparable or higher than those of ZN-catalyzed polypropylenes having an MFR of 35 (PP3155, available from ExxonMobil Chemical Company, Houston, Tex.) and MFR 70, respectively.

Unimodal solution metallocene polypropylene displayed lower modulus in injected molded specimen due to lower level of shear thinning during the injection molding procedure. Unimodal metallocene-catalyzed polypropylene having MFR 70 can be made using dimethylaniliniumtetrakis(perfluorophenyl)borate-activated dimethyl (μ-dimethylsilyl)bis(2-methyl-4-(3′5′-di-tert-butylphenyl)indenyl)zirconium at a temperature of around 106-107° C. and pressure of 657-661 psig (˜4.52-4.56 MPa).

TABLE 3
Flexural moduli of Ziegler-Natta-catalyzed polypropylene,
metallocene-catalyzed bimodal polypropylene compositions
of the invention, and unimodal metallocene polypropylene

| | Flex | Shear |
|---|---|---|
| | modulus | Thinning |
| Samples | (MPa) | Index* |
| Ziegler-Natta polypropylene MFR 70 | 1650 | 3.5 |
| Bimodal metallocene polypropylene MFR 70 | 1630 | 3.2 |
| (inventive) | | |
| Ziegler-Natta polypropylene MFR 35 (PP3155) | 1311 | 5.2 |
| Bimodal metallocene polypropylene MFR 35 | 1660 | 5.0 |
| (inventive) | | |
| Unimodal metallocene polypropylene MFR 70 | 1355 | 1.3 |

*Shear thinning index = (eta*@0.1 rad/s)/(eta*@ 100 rad/s)

Aspects of the invention are provided in the following embodiments:
Paragraph 1. A method for making a bimodal polypropylene composition, comprising (or consisting essentially of, or consisting of):
   a) contacting in a first reactor propylene monomers with a first single-site catalyst in solution to form a first polypropylene having an MFR of 0.5 to 5 dg/min;
   b) contacting in a second reactor propylene monomers with a second single-site catalyst in solution to form a second polypropylene having an MFR of 120 to 550 dg/min;
   c) combining the first polypropylene and second polypropylene to form a bimodal polypropylene composition, wherein the bimodal polypropylene composition has an MFR of 30 to 100 dg/min; and
   d) recovering the bimodal polypropylene composition.
Paragraph 2. The method of Paragraph 1, wherein first reactor and the second reactor are in series configuration or in parallel configuration; wherein when in series configuration the first polypropylene is also contacted in the second reactor with monomers and the second single-site catalyst in solution.
Paragraph 3. The method of Paragraph 1, wherein the bimodal polypropylene composition has a flexural modulus of at least 1400 MPa.
Paragraph 4. The method of any of the preceding Paragraphs, wherein the bimodal polypropylene composition has a shear thinning index (200° C., complex viscosity @ 1E-02 rad/s/complex viscosity @ 1E+02 rad/s) of at least 2.
Paragraph 5. The method of any of the preceding Paragraphs, wherein the first polypropylene has an MFR of 0.8 to 2 dg/min.
Paragraph 6. The method of any of the preceding Paragraphs, wherein the second polypropylene has an MFR of 200 to 400 dg/min.
Paragraph 7. The method of any of the preceding Paragraphs, wherein at least one of the first and second single-site catalysts is a metallocene catalyst.
Paragraph 8. The method of any of the preceding Paragraphs, wherein at least one of the first and second single-site catalysts has the following formula:

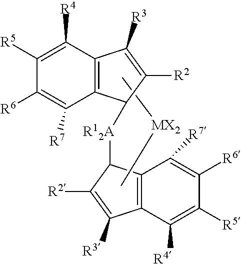

where M is a Group 4 metal; each X is a halogen or C₁ to C₁₀ alkyl; A is a tetravalent atom; each R¹ is independently selected from hydrogen and C₁ to C₁₀ alkyls; each of R⁴ and R^{4′} is selected from bulky substituents such as phenyl or naphthyl groups, and heterocyclic aromatic hydrocarbons; and each of R², R³, R⁵ to R⁷, and R^{2′}, R^{3′}, and R^{5′} to R^{7′} is selected from hydrogen and C₁ to C₁₀ alkyls.
Paragraph 9. The method of any of the preceding Paragraphs, wherein the first single-site catalyst is dimethyl (μ-dimethylsilyl)bis(2-methyl-4-(N-carbazolyl)indenyl)zirconium.
Paragraph 10. The method of any of the preceding Paragraphs, wherein the first single-site catalyst is combined with dimethylaniliniumtetrakis(heptafluoronaphthyl)borate.
Paragraph 11. The method of any of the preceding Paragraphs, wherein the second single-site catalyst is dimethyl (μ-dimethylsilyl)bis(2-methyl-4-(3′5′-di-tert-butylphenyl)indenyl)zirconium.
Paragraph 12. The method of any of the preceding Paragraphs, wherein the second single-site catalyst is combined with dimethylaniliniumtetrakis(perfluorophenyl)borate.
Paragraph 13. The method of any of the preceding Paragraphs, wherein the first and second single-site catalysts are the same, and the second reactor further comprises a chain transfer agent.
Paragraph 14. The method of any of the preceding Paragraphs, wherein the first and second single-site catalysts are dimethyl (μ-dimethylsilyl)bis(2-methyl-4-(N-carbazolyl)indenyl)zirconium.
Paragraph 15. The method of any of the preceding Paragraphs, wherein the temperature in at least one of the first and second reactors is 90 to 160° C.
Paragraph 16. The method of any of the preceding Paragraphs, wherein the pressure in at least one of the first and second reactors is 3.5 to 34.5 MPa.
Paragraph 17. The method of any of the preceding Paragraphs, wherein the first polypropylene and second polypropylene are combined in solution.
Paragraph 18. A bimodal polypropylene composition made by the method of any of the preceding Paragraphs.
Paragraph 19. A bimodal polypropylene composition comprising:
   a) a first polypropylene having an MFR of 0.5 to 5 dg/min; and
   b) a second polypropylene having an MFR of 120 to 550 dg/min;
wherein the bimodal polypropylene composition has an MFR of 30 to 100 dg/min, a flexural modulus of at least 1400 MPa, and a shear thinning index (200° C., complex viscosity @1E-02 rad/s/complex viscosity @ 1E+02 rad/s) of at least 2.
Paragraph 20. The bimodal polypropylene composition of Paragraph 19 having an MFR of 35 to 70 dg/min.
Paragraph 21. The bimodal polypropylene composition of Paragraphs 19-20, wherein the first polypropylene has an MFR of 1 dg/min, and the second polypropylene has an MFR of 300 dg/min.
Paragraph 22. The bimodal polypropylene composition of Paragraphs 19-21 having a flexural modulus of at least 1600 MPa, and a shear thinning index of at least 3.5.
Paragraph 23. The bimodal polypropylene composition of Paragraphs 19-22, wherein the first and second polypropylene are isotactic propylene homopolymers having less than 100 regio defects (sum of 2,1-erythro and 3,1-isomerizations) per 10,000 propylene units.
Paragraph 24. The bimodal polypropylene composition of Paragraphs 19-23, wherein the first and second polypropylene have at least one of:
   a) a peak melting temperature of greater than 149° C.;
   b) an mmmm pentad fraction of 0.85 or more; and
   c) a heat of fusion of 80 J/g or more.
Paragraph 25. The bimodal polypropylene composition of Paragraphs 19-24, wherein the first and second polypropylene have at least one of:
   a) a peak melting temperature of greater than 153° C.;
   b) an mmmm pentad fraction of 0.9 or more; and
   c) a heat of fusion of 90 J/g or more.
Paragraph 26. A method for making a bimodal polypropylene composition, comprising:
   a) contacting in a first reactor propylene monomers with (μ-dimethylsilyl)bis(2-methyl-4-(N-carbazolyl)indenyl)zirconium in solution to form a first polypropylene having an MFR of 0.8 to 2 dg/min;
   b) contacting in a second reactor propylene monomers with a second metallocene catalyst in solution to form a second polypropylene having an MFR of 200 to 400 dg/min;
   c) combining in solution the first polypropylene and second polypropylene to form a bimodal polypropylene composition, wherein the bimodal polypropylene composition has an MFR of 35 to 70 dg/min, a flexural modulus of at least 1400 MPa, and a shear thinning index (200° C., complex viscosity @ 1E-02 rad/s/complex viscosity @ 1E+02 rad/s) of at least 2; and
   d) recovering the bimodal polypropylene composition in solid form.

When numerical lower limits and numerical upper limits are listed herein, ranges from any lower limit to any upper limit are contemplated. The term “comprising” is synonymous with the term “including”. Likewise whenever a composition, an element or a group of components is preceded with the transitional phrase “comprising”, it is understood that we also contemplate the same composition or group of components with transitional phrases “consisting essentially of”, “consisting of”, “selected from the group of consisting of”, or “is” preceding the recitation of the composition, component, or components, and vice versa.

As used herein, “consisting essentially of” means that the claimed composition includes only the named components and no additional components that will alter its measured properties by any more than 20%, and most preferably means that additional components are present to a level of less than 5, or 4, or 3, or 2 wt % by weight of the composition. Such additional components can include, for example, fillers, colorants, antioxidants, anti-UV additives, curatives and cross-linking agents, aliphatic and/or cyclic containing oligomers or polymers, often referred to as hydrocarbon resins, and other additives well known in the art. In a process, “consisting essentially of” means that there are no other process steps or components that will chemically or physically alter the properties of the final product to any more than 5, or 4, or 3, or 2, or 1% of its value without the additional step or component.

For all jurisdictions in which the doctrine of “incorporation by reference” applies, all of the test methods, patent publications, patents and reference articles are hereby incorporated by reference either in their entirety or for the relevant portion for which they are referenced.

1. A method for making a bimodal polypropylene composition, comprising:
a) contacting in a first reactor propylene monomers with a first single-site catalyst in solution to form a first polypropylene having an MFR of 0.5 to 5 dg/min;
b) contacting in a second reactor propylene monomers with a second single-site catalyst in solution to form a second polypropylene having an MFR of 120 to 550 dg/min;
c) combining the first polypropylene and second polypropylene to form a bimodal polypropylene composition, wherein the bimodal polypropylene composition has an MFR of 30 to 100 dg/min; and
d) recovering the bimodal polypropylene composition.

2. The method of claim 1, wherein the bimodal polypropylene composition has a flexural modulus of at least 1400 MPa.

3. The method of claim 1, wherein the bimodal polypropylene composition has a shear thinning index (200° C., complex viscosity @ 1E-02 rad/s/complex viscosity @ 1E+02 rad/s) of at least 2.

4. The method of claim 1, wherein the first polypropylene has an MFR of 0.8 to 2 dg/min.

5. The method of claim 1, wherein the second polypropylene has an MFR of 200 to 400 dg/min.

6. The method of claim 1, wherein at least one of the first and second single-site catalysts is a metallocene catalyst.

7. The method of claim 1, wherein at least one of the first and second single-site catalysts has the following formula: 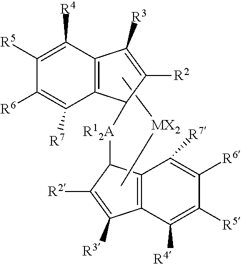
where M is a Group 4 metal; each X is a halogen or C₁ to C₁₀ alkyl; A is a tetravalent atom; each R¹ is independently selected from hydrogen and C₁ to C₁₀ alkyls; each of R⁴ and R^{4′} is selected from phenyl groups, naphthyl groups, and heterocyclic aromatic hydrocarbons; and each of R², R³, R⁵ to R⁷, and R^{2′}, R^{3′}, and R^{5′} to R^{7′} is selected from hydrogen and C₁ to C₁₀ alkyls.

8. The method of claim 1, wherein the first single-site catalyst is dimethyl (μ-dimethylsilyl)bis(2-methyl-4-(N-carbazolyl)indenyl)zirconium.

9. The method of claim 1, wherein the first single-site catalyst is combined with dimethylaniliniumtetrakis(heptafluoronaphthyl)borate.

10. The method of claim 1, wherein the second single-site catalyst is dimethyl (μ-dimethylsilyl)bis(2-methyl-4-(3′5′-di-tert-butylphenyl)indenyl)zirconium.

11. The method of claim 1, wherein the second single-site catalyst is combined with dimethylaniliniumtetrakis(perfluorophenyl)borate.

12. The method of claim 1, wherein the first and second single-site catalysts are the same, and the second reactor further comprises a chain transfer agent.

13. The method of claim 1, wherein the first and second single-site catalysts are dimethyl (μ-dimethylsilyl)bis(2-methyl-4-(N-carbazolyl)indenyl)zirconium.

14. The method of claim 1, wherein the temperature in at least one of the first and second reactors is 90 to 160° C.

15. The method of claim 1, wherein first reactor and the second reactor are in series configuration or in parallel configuration.

16. The method of claim 1, wherein the first polypropylene and second polypropylene are combined in solution.

17. A bimodal polypropylene composition made by the method of claim 1.

18. A bimodal polypropylene composition comprising:
a) a first polypropylene having an MFR of 0.5 to 5 dg/min; and
b) a second polypropylene having an MFR of 120 to 550 dg/min;
c) wherein the bimodal polypropylene composition has an MFR of 30 to 100 dg/min, a flexural modulus of at least 1400 MPa, and a shear thinning index (200° C., complex viscosity @ 1E-02 rad/s/complex viscosity @ 1E+02 rad/s) of at least 2.

19. The bimodal polypropylene composition of claim 18 having an MFR of 35 to 70 dg/min.

20. The bimodal polypropylene composition of claim 18, wherein the first polypropylene has an MFR of 1 dg/min, and the second polypropylene has an MFR of 300 dg/min.

21. The bimodal polypropylene composition of claim 18 having a flexural modulus of at least 1600 MPa, and a shear thinning index of at least 3.5.

22. The bimodal polypropylene composition of claim 18, wherein the first and second polypropylene are isotactic propylene homopolymers having less than 100 regio defects (sum of 2,1-erythro and 3,1-isomerizations) per 10,000 propylene units.

23. The bimodal polypropylene composition of claim 18, wherein the first and second polypropylene have at least one of:
a) a peak melting temperature of greater than 149° C.;
b) an mmmm pentad fraction of 0.85 or more; and
c) a heat of fusion of 80 J/g or more.

24. The bimodal polypropylene composition of claim 18, wherein the first and second polypropylene have at least one of:
a) a peak melting temperature of greater than 153° C.;
b) an mmmm pentad fraction of 0.9 or more; and
c) a heat of fusion of 90 J/g or more.

25. A method for making a bimodal polypropylene composition, comprising:
a) contacting in a first reactor propylene monomers with (μ-dimethylsilyl)bis(2-methyl-4-(N-carbazolyl)indenyl)zirconium in solution to form a first polypropylene having an MFR of 0.8 to 2 dg/min;
b) contacting in a second reactor propylene monomers with a second metallocene catalyst in solution to form a second polypropylene having an MFR of 200 to 400 dg/min;
c) combining in solution the first polypropylene and second polypropylene to form a bimodal polypropylene composition, wherein the bimodal polypropylene composition has an MFR of 35 to 70 dg/min, a flexural modulus of at least 1400 MPa, and a shear thinning index (200° C., complex viscosity @ 1E-02 rad/s/complex viscosity @ 1E+02 rad/s) of at least 2; and
d) recovering the bimodal polypropylene composition in solid form.
